(19) United States
(12) Patent Application Publication
(10) Pub. No.: US 2024/0232932 A1
(43) Pub. Date: Jul. 11, 2024

(54) STAKE SHARING PROCESSING METHOD AND APPARATUS

(71) Applicant: Alipay (Hangzhou) Information Technology Co., Ltd., Hangzhou (CN)

(72) Inventor: Xiang WANG, Hangzhou (CN)

(21) Appl. No.: 18/560,048

(22) PCT Filed: Apr. 29, 2022
(86) PCT No.: PCT/CN2022/090142

§ 371 Date: Nov. 9, 2023

(30) Foreign Application Priority Data
May 13, 2021 (CN) 202110521430.8

(51) Int. Cl. G06Q 30/0207

(52) U.S. Cl. CPC G06Q 30/0224

(57) ABSTRACT

Some embodiments of this specification provide a stake sharing processing method and apparatus, where the stake sharing processing method includes: obtaining a sharing request of a sharing user for sharing a stake resource with at least one shared user; performing credibility verification on the at least one shared user based on the sharing request, to obtain a user set of a target user passing the verification; determining whether a resource parameter of the stake resource meets a corresponding sharing condition; and if the resource parameter of the stake resource meets the corresponding sharing condition, adding the target user to a stake relationship between the sharing user and the stake resource, so that the target user obtains a resource permission of the stake resource.

### TECHNICAL FIELD

This specification relates to the field of data processing technologies, and in particular, to a stake sharing processing method and apparatus.

### BACKGROUND

With rapid development of Internet technologies, network consumption is widely popularized, and more merchants sell products by using network platforms. At the same time, various network platforms are emerging. Therefore, competition among network platforms and among merchants is also increasingly intensified. To improve their competitiveness, network platforms or merchants often carry out some online marketing campaigns, for example, distribute stakes such as red envelopes, coupons, and gift coupons to users participating in the marketing campaigns. Therefore, it is particularly important to implement greater utilization of stake resources and improve usage of the stake resources.

### SUMMARY

One or more embodiments of this specification provide a stake sharing processing method. The stake sharing processing method includes: obtaining a sharing request of a sharing user for sharing a stake resource with at least one shared user; performing credibility verification on the at least one shared user based on the sharing request, to obtain a user set of a target user passing the verification; determining whether a resource parameter of the stake resource meets a corresponding sharing condition; and if the resource parameter of the stake resource meets the corresponding sharing condition, adding the target user to a stake relationship between the sharing user and the stake resource, so that the target user obtains a resource permission of the stake resource.

One or more embodiments of this specification provide a blockchain-based stake write-off processing method, including: invoking, based on a write-off request of a sharing user or a shared user that is sent by a server, a smart contract deployed by the blockchain node to query a stake resource corresponding to a service type of a stake write-off request; detecting whether the stake relationship table records a stake relationship of the sharing user or the shared user; if the stake relationship table records the stake relationship of the sharing user or the shared user, and if the resource status of the stake resource read from the blockchain is an unused state, sending an availability reminder to the server, and writing off the stake resource when a write-off confirmation request sent by the server is received; and returning a stake write-off result to the server, and updating a write-off status of the stake resource to the blockchain.

One or more embodiments of this specification provide another blockchain-based stake write-off processing method, including: obtaining a service request for a service type that is submitted by a sharing user or a shared user, and sending the service request as a stake write-off request to a blockchain node in a blockchain; receiving an availability reminder of a stake resource sent by the blockchain node, and sending the availability reminder to the sharing user or the shared user; and performing settlement based on the stake resource, and sending a write-off confirmation request to the blockchain node after the settlement succeeds.

One or more embodiments of this specification provide a stake sharing processing apparatus, including: an obtaining module, configured to obtain a sharing request of a sharing user for sharing a stake resource with at least one shared user; a verification module, configured to perform credibility verification on the at least one shared user based on the sharing request, to obtain a user set of a target user passing the verification; a determining module, configured to determine whether a resource parameter of the stake resource meets a corresponding sharing condition; and if the resource parameter of the stake resource meets the corresponding sharing condition, an adding module is run, where the adding module is configured to add the target user to a stake relationship between the sharing user and the stake resource, so that the target user obtains a resource permission of the stake resource.

One or more embodiments of this specification provide a blockchain-based stake write-off processing apparatus, including: a querying module, configured to invoke, based on a write-off request of a sharing user or a shared user that is sent by a server, a smart contract deployed by the blockchain node to query a stake resource corresponding to a service type of a stake write-off request; a detecting module, configured to detect whether the stake relationship table records a stake relationship of the sharing user or the shared user; if the stake relationship table records the stake relationship of the sharing user or the shared user, and if the resource status of the stake resource read from the blockchain is an unused state, a write-off module is run, where the write-off module is configured to send an availability reminder to the server, and write off the stake resource when a write-off confirmation request sent by the server is received; and an updating module, configured to return a stake write-off result to the server, and update a write-off status of the stake resource to the blockchain.

One or more embodiments of this specification provide another blockchain-based stake write-off processing apparatus, including: a service request receiving module, configured to obtain a service request for a service type that is submitted by a sharing user or a shared user, and send the service request as a stake write-off request to a blockchain node in a blockchain; an availability reminder receiving module, configured to receive an availability reminder of a stake resource sent by the blockchain node, and send the availability reminder to the sharing user or the shared user; and a write-off request module, configured to perform settlement based on the stake resource, and send a write-off confirmation request to the blockchain node after the settlement succeeds.

One or more embodiments of this specification provide a stake sharing processing device, including: a processor; and a memory configured to store a computer-executable instruction, where when being executed, the computer-executable instruction enables the processor to perform the following operations: obtaining a sharing request of a sharing user for sharing a stake resource with at least one shared user; performing credibility verification on the at least one shared user based on the sharing request, to obtain a user set of a target user passing the verification; determining whether a resource parameter of the stake resource meets a corresponding sharing condition; and if the resource parameter of the stake resource meets the corresponding sharing condition, adding the target user to a stake relationship between the sharing user and the stake resource, so that the target user obtains a resource permission of the stake resource.

One or more embodiments of this specification provide a blockchain-based stake write-off processing device, including: a processor; and a memory configured to store a computer-executable instruction, where when being executed, the computer-executable instruction enables the processor to perform the following operations: invoking, based on a write-off request of a sharing user or a shared user that is sent by a server, a smart contract deployed by the blockchain node to query a stake resource corresponding to a service type of a stake write-off request; detecting whether the stake relationship table records a stake relationship of the sharing user or the shared user; if the stake relationship table records the stake relationship of the sharing user or the shared user, and if the resource status of the stake resource read from the blockchain is an unused state, sending an availability reminder to the server, and writing off the stake resource when a write-off confirmation request sent by the server is received; and returning a stake write-off result to the server, and updating a write-off status of the stake resource to the blockchain.

One or more embodiments of this specification provide another blockchain-based stake write-off processing device, including: a processor; and a memory configured to store a computer-executable instruction, where when being executed, the computer-executable instruction enables the processor to perform the following operations: obtaining a service request for a service type that is submitted by a sharing user or a shared user, and sending the service request as a stake write-off request to a blockchain node in a blockchain; receiving an availability reminder of a stake resource sent by the blockchain node, and sending the availability reminder to the sharing user or the shared user; and performing settlement based on the stake resource, and sending a write-off confirmation request to the blockchain node after the settlement succeeds.

One or more embodiments of this specification provide a first storage medium, configured to store a computer-executable instruction, where the computer-executable instruction is executed to implement the following procedure: obtaining a sharing request of a sharing user for sharing a stake resource with at least one shared user; performing credibility verification on the at least one shared user based on the sharing request, to obtain a user set of a target user passing the verification; determining whether a resource parameter of the stake resource meets a corresponding sharing condition; and if the resource parameter of the stake resource meets the corresponding sharing condition, adding the target user to a stake relationship between the sharing user and the stake resource, so that the target user obtains a resource permission of the stake resource.

One or more embodiments of this specification provide a second storage medium, configured to store a computer-executable instruction, where the computer-executable instruction is executed to implement the following procedure: invoking, based on a write-off request of a sharing user or a shared user that is sent by a server, a smart contract deployed by the blockchain node to query a stake resource corresponding to a service type of a stake write-off request; detecting whether the stake relationship table records a stake relationship of the sharing user or the shared user; if the stake relationship table records the stake relationship of the sharing user or the shared user, and if the resource status of the stake resource read from the blockchain is an unused state, sending an availability reminder to the server, and writing off the stake resource when a write-off confirmation request sent by the server is received; and returning a stake write-off result to the server, and updating a write-off status of the stake resource to the blockchain.

One or more embodiments of this specification provide a third storage medium, configured to store a computer-executable instruction, where the computer-executable instruction is executed to implement the following procedure: obtaining a service request for a service type that is submitted by a sharing user or a shared user, and sending the service request as a stake write-off request to a blockchain node in a blockchain; receiving an availability reminder of a stake resource sent by the blockchain node, and sending the availability reminder to the sharing user or the shared user; and performing settlement based on the stake resource, and sending a write-off confirmation request to the blockchain node after the settlement succeeds.

### BRIEF DESCRIPTION OF DRAWINGS

FIG. 1 is a processing flowchart of a stake sharing processing method according to one or more embodiments of this specification;

FIG. 2 shows a stake sharing processing method that is applied to a multi-user sharing scenario according to one or more embodiments of this specification;

FIG. 3 is a processing flowchart of a blockchain-based stake write-off processing method according to one or more embodiments of this specification;

FIG. 4 is a processing flowchart of another blockchain-based stake write-off processing method according to one or more embodiments of this specification;

FIG. 5 is a schematic diagram of a stake sharing processing apparatus according to one or more embodiments of this specification;

FIG. 6 is a schematic diagram of a blockchain-based stake write-off processing apparatus according to one or more embodiments of this specification;

FIG. 7 is a schematic diagram of another blockchain-based stake write-off processing apparatus according to one or more embodiments of this specification;

FIG. 8 is a schematic structural diagram of a stake sharing processing device according to one or more embodiments of this specification;

FIG. 9 is a schematic structural diagram of a blockchain-based stake write-off processing device according to one or more embodiments of this specification; and

FIG. 10 is a schematic structural diagram of another blockchain-based stake write-off processing device according to one or more embodiments of this specification.

### DESCRIPTION OF EMBODIMENTS

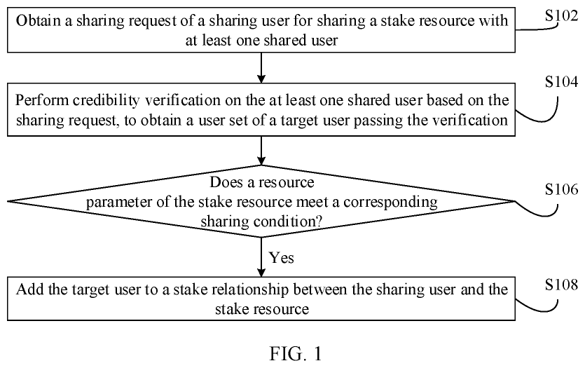

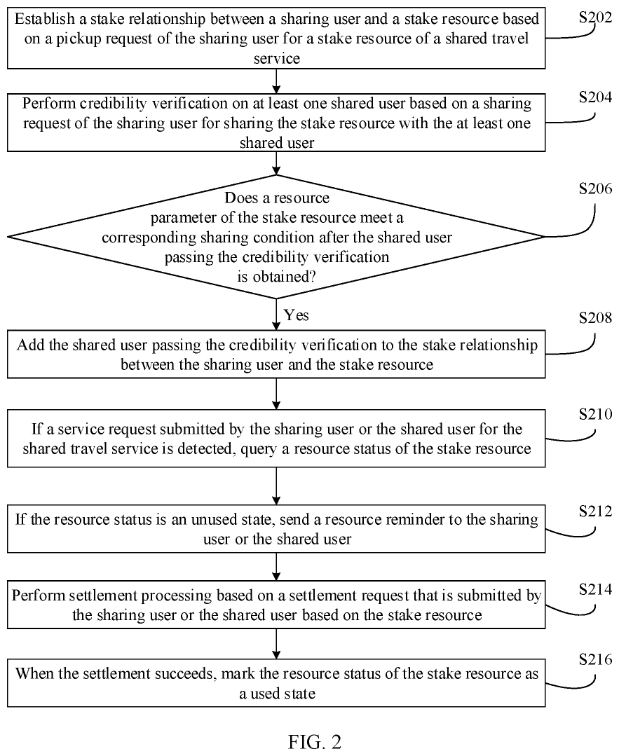

This specification provides some embodiments of a stake sharing processing method. FIG. 1 is a processing flowchart of a stake sharing processing method according to some embodiments of this specification. FIG. 2 shows a stake sharing processing method that is applied to a multi-user sharing scenario according to some embodiments of this specification.

Referring to FIG. 1, the stake sharing processing method provided in these embodiments specifically includes step S102 to step S108.

Step S102: Obtain a sharing request of a sharing user for sharing a stake resource with at least one shared user.

In practice, a user who picks up a stake resource usually does not use the stake resource, but a user who needs to use the stake resource fails to pick up the related stake resource for various reasons, affecting usage of the stake resource. According to the stake sharing processing method provided in these embodiments, the user who picks up the stake resource shares the stake resource with another user, thereby implementing use of the stake resource by a plurality of accounts. Specifically, the sharing user selects a shared user to share the stake resource. When credibility verification on the shared user succeeds and the shared stake resource meets a sharing condition, the shared user is added to a stake relationship between the sharing user and the stake resource, so that both the sharing user and the shared user obtain a resource permission of the stake resource, thereby implementing greater utilization of the stake resource and improving usage of the stake resource.

In these embodiments, the sharing user includes a user who picks up a stake resource and shares the obtained stake resource with another user, and the another user with whom the stake resource is shared is the shared user. The stake resource includes an object that is provided by a recommended item to a user and that has economic value or other dimension value, such as a cash red envelope, a coupon, and a periodic card. It should be noted that after picking up a stake resource, the user can view and use the stake resource. In addition, the stake resource can be distributed to a user account, so that the user can use the stake resource in a specific scenario or channel. The recommended item is a service item that distributes a stake resource to a user to increase a participation level of the user, such as a public transportation travel promotion campaign or a shared vehicle travel promotion campaign. The sharing request includes a resource label of the stake resource, a user identifier of the sharing user, a user identifier of the shared user, and/or a sharing time. In addition, the sharing request may further include other information that needs to be processed by a server, which is not limited in these embodiments.

During specific implementation, to share a stake resource with the shared user, the sharing user needs to obtain the stake resource first. A resource permission of the sharing user to the stake resource is determined by using a stake relationship between the sharing user and the stake resource. To ensure that the sharing user is a trusted user and to avoid a resource loss, in some optional implementations provided in these embodiments, in a process of distributing a stake resource to the sharing user, credibility verification is performed on the sharing user, and the stake resource is distributed to the sharing user by establishing a stake relationship between the sharing user and the stake resource when the credibility verification succeeds. Specifically, the stake resource is distributed by using the following method: performing credibility verification on the sharing user based on an access request of the sharing user for a recommended item; if the verification succeeds, sending a resource label of a recommended stake resource to the sharing user; and establishing a recommended stake relationship between the sharing user and the recommended stake resource based on a pickup request of the sharing user for the recommended stake resource, where the stake resource is a part or a whole of the recommended stake resource, and the recommended stake relationship includes the stake relationship.

Specifically, when the sharing user accesses the recommended item, credibility verification is performed on the sharing user. When the verification succeeds, at least one corresponding recommended stake resource is queried from a stake platform based on an item identifier of the recommended item, and a resource label of the recommended stake resource is displayed to the sharing user. When the sharing user submits a pickup request for any one or more recommended stake resources, a stake relationship between the sharing user and the recommended stake resource that needs to be picked up is established.

For example, after an access request of a user A for a shared bicycle promotion campaign is obtained, whether the user A is a blacklisted/graylisted user is verified based on a blacklist/graylist stored in an account platform. After it is verified that the user A does not belong to a blacklist/graylist, a recommended stake resource corresponding to the shared bicycle promotion campaign is queried from a stake platform based on an item type carried in the access request. The identified recommended stake resource includes five two-yuan cash red envelopes and one time for purchasing a monthly card at a 50% discount. A corresponding resource label is sent to the sharing user. When a pickup request of the user for the five two-yuan cash red envelopes is obtained, an association relationship between the user A and the five two-yuan cash red envelopes is established. After the establishment, when the user A views the stake resource, a resource label of the stake resource for which the association relationship is established is displayed to the user A.

During specific implementation, after picking up the recommended stake resource, the sharing user can share a part or a whole of the obtained recommended stake resource. When sharing the stake resource, the sharing user needs to select a shared user. To reduce a procedure that the sharing user needs to perform when sharing the stake resource, and to improve sharing experience of the sharing user, in some optional implementations provided in these embodiments, the sharing user can set a default shared user in advance. If the user has set a default shared user in advance, when the sharing user triggers a sharing control of the stake resource, by default, the stake resource is shared with the default shared user set by the sharing user, and the sharing user does not need to select a shared user again. If the sharing user does not set a default shared user, when the sharing user triggers the sharing control of the stake resource, the sharing user needs to select and submit a shared user. The shared user is obtained by using the following method: when it is detected that the sharing user triggers a sharing control of the stake resource, querying whether the sharing user sets a default shared user; if the sharing user sets the default shared user, determining the default shared user as the at least one shared user; if the sharing user sets no default shared user, generating a user selection page based on a friend list of the sharing user; and when it is detected that the sharing user triggers a sharing confirmation control configured on the user selection page, determining that at least one user selected by the sharing user by using the user selection page, and/or at least one user queried and selected by the sharing user by using the user selection page is the at least one shared user.

Specifically, when it is detected that the sharing user triggers a sharing control of the stake resource, whether the sharing user sets a default shared user is queried. If the sharing user sets the default shared user, the default shared user is used as the shared user. If the sharing user sets no default shared user, a user selection page is generated based on a friend list of the sharing user, and a friend user selected by the sharing user by using the user selection page or a non-friend user queried and selected by the sharing user is used as the shared user.

For example, after the user A obtains the five two-yuan cash red envelopes, when it is detected that the user A triggers a sharing control configured in a resource label display area of the five two-yuan cash red envelopes, whether the user A sets a default shared user is detected. When it is detected that the user A sets a user B, a user C, and a user D as default shared users, the five two-yuan cash red envelopes are shared with the user B, the user C, and the user D.

For another example, after the user A obtains the five two-yuan cash red envelopes, when it is detected that the user A triggers a sharing control configured in a resource label display area of the five two-yuan cash red envelopes, it is detected that the user A does not set a default shared user. In such case, a user selection page is generated based on a friend list of the user A, and the user A selects the user B and the user C from the friend list by using the user selection page, and queries and selects the user D having no friend relationship with the user A as shared users.

Step S104: Perform credibility verification on the at least one shared user based on the sharing request, to obtain a user set of a target user passing the verification.

The credibility verification means verifying whether the at least one shared user is a blacklisted/graylisted user. The target user is a shared user passing the credibility verification. The user set includes at least one shared user passing the credibility verification.

During specific implementation, to improve security of a stake resource in a stake sharing process, the stake resource can be shared with the shared user by the sharing user only when the shared user passes the credibility verification. Therefore, when at least one shared user is submitted by the sharing user, the stake resource is shared with the shared user passing the credibility verification.

Step S106: Determine whether a resource parameter of the stake resource meets a corresponding sharing condition.

The resource parameter includes a resource type, a sharing time, and/or a resource status. In addition, the resource parameter may further include an amount threshold for the stake resource, and the like. The resource parameter is determined based on actual service needs, which is not limited in these embodiments.

During specific implementation, to further ensure security of a stake resource in a stake sharing process, in some optional implementations provided in these embodiments, after credibility verification is performed on the shared user and the credibility verification succeeds, it is necessary to further determine whether the resource parameter of the stake resource meets a corresponding sharing condition. Specifically, the determining whether the resource parameter of the stake resource meets a corresponding sharing condition is implemented mainly by using the following method: determining whether the resource type of the stake resource is a shareable resource type, determining whether the sharing time is in a sharing time interval, and/or determining whether the resource status of the stake resource is an unused state. In addition, it can be further determined whether a resource amount of the stake resource exceeds the amount threshold.

Specifically, the above-mentioned determining may be determining of the above-mentioned three conditions, or may be determining of any one or two of the above-mentioned three conditions. After the determining, if the resource parameter meets the corresponding sharing condition, the target user is added to the stake relationship between the sharing user and the stake resource.

In addition, sharing failure may be caused by different resource types, different sharing times, other factors, or the like. Therefore, to increase a perception degree of a sharing user for a sharing failure cause, in some optional implementations provided in these embodiments, if an execution result after performing a step of determining whether a resource parameter of the stake resource meets a corresponding sharing condition is that the resource parameter of the stake resource does not meet the corresponding sharing condition, the following operations are performed: reading a sharing failure cause based on a determining result; and sending a sharing failure reminder to the sharing user based on the sharing failure cause.

For example, the user A shares five two-yuan cash red envelopes with the user B, the user C, and the user D. After the user B, the user C, and the user D pass credibility verification, whether the shared bicycle promotion campaign corresponding to the five two-yuan cash red envelopes belongs to a shareable stake item is determined. If the shared bicycle promotion campaign corresponding to the five two-yuan cash red envelopes does not belong to a shareable stake item, a reminder indicating that the resource type is unshareable is returned to the user A. If the shared bicycle promotion campaign corresponding to the five two-yuan cash red envelopes belongs to a shareable stake item, whether the sharing time of the five two-yuan cash red envelopes is in the sharing time interval is determined. If the sharing time of the five two-yuan cash red envelopes is not in the sharing time interval, a reminder indicating that the current time is unshareable and the sharing time ranges from xx o'clock to xx o'clock is returned to the user A. If the sharing time of the five two-yuan cash red envelopes is in the sharing time interval, whether a resource status of the five two-yuan cash red envelopes is an unused state is determined. If the resource status of the five two-yuan cash red envelopes is not an unused state, a reminder indicating that the resource is in use is returned to the user A. If the resource status of the five two-yuan cash red envelopes is an unused state, the user B, the user C, and the user D are added to the stake relationship between the user A and the five two-yuan cash red envelopes.

Step S108: Add the target user to a stake relationship between the sharing user and the stake resource.

During specific implementation, the target user is added to the stake relationship between the sharing user and the stake resource, so that the target user obtains the resource permission of the stake resource. After obtaining the resource permission, the target user can view and use the stake resource in the account. After the stake resource is shared, both the sharing user and the target user can view and use the stake resource. To increase a perception degree of a use status of the stake resource, in some optional implementations provided in these embodiments, when the sharing user or the target user views the stake resource, the resource label is displayed by using the following method: if it is detected that the sharing user or the target user submits an access request for the stake resource, querying a resource status of the stake resource; and displaying a resource label of the stake resource to the sharing user or the target user based on the resource status.

Specifically, when the sharing user or the target user accesses the stake resource, the resource status of the stake resource is queried. If the resource status of the stake resource is a used state, a resource label that carries a used mark is displayed to the sharing user or the target user. If the resource status is an unused state, a resource label that carries an available mark is displayed to the sharing user or the target user.

In addition, if there are a plurality of stake resources, to increase a perception degree of use statuses of the stake resources, in some optional implementations provided in these embodiments, if it is detected that the sharing user or the target user submits an access request for the stake resource, a resource status of the stake resource is queried to obtain a remaining stake resource whose resource status is an unused state; and a resource label of the stake resource is displayed to the sharing user or the target user based on a quantity of remaining stake resources.

For example, the user A shares five two-yuan cash red envelopes with the user B, the user C, and the user D. The user B needs to view the obtained stake resource. When an access request of the user B for the account stake is detected, the resource statuses of the five two-yuan cash red envelopes are queried, and it is identified that the resource statuses of three two-yuan cash red envelopes are a used state, and the resource statuses of two two-yuan cash red envelopes are an unused state. In such case, a resource label that carries an available resource quantity of 2 is displayed to the user B.

During specific implementation, the sharing user or the target user can use the stake resource when accessing a service corresponding to the stake resource. In some optional implementations provided in these embodiments, when the sharing user or the target user accesses the corresponding service, the following operations are performed: if it is detected that the sharing user or the target user submits a service request for a recommended item corresponding to the stake resource, querying a resource status of the stake resource; if the resource status is an unused state, sending a resource reminder to the sharing user or the target user; performing settlement processing based on a settlement request that is based on the stake resource and that is submitted by the sharing user or the target user; and performing, by a stake platform, resource write-off on the stake resource in a case of settlement success.

Specifically, when it is detected that the sharing user or the target user submits the service request for the service item corresponding to the stake resource, the resource status of the stake resource is queried. If there is a stake resource whose resource status is an unused state, a resource reminder is sent to the sharing user or the target user, and then settlement processing is performed based on the settlement request submitted by the sharing user or the target user. After the settlement processing, the stake platform marks the resource status of the used stake resource as the used state.

In some optional implementations provided in these embodiments, settlement processing is specifically performed by using the following method: sending a write-off request to the stake platform based on the settlement request, and obtaining a resource settlement amount of the stake resource from the stake platform; and determining an actual settlement amount based on the resource settlement amount and a settlement amount in the settlement request, and performing, by a payment platform, fund transfer based on the actual settlement amount, where after the fund transfer succeeds, the payment platform sends a write-off confirmation reminder to the stake platform, so that the stake platform marks the resource status of the stake resource as a used state based on the write-off confirmation reminder.

For example, the user A shares five two-yuan cash red envelopes with the user B, the user C, and the user D, and it is detected that the user B accesses the shared bicycle promotion campaign. In such case, the resource statuses of the five two-yuan cash red envelopes are queried, and it is identified that the resource statuses of three two-yuan cash red envelopes are a used state, and the resource statuses of two two-yuan cash red envelopes are an unused state. Then, a resource reminder of the two-yuan cash red envelope is sent to the user B. After a settlement request submitted by the user B for the two-yuan cash red envelope is obtained, the two-yuan cash red envelope is obtained from the stake platform based on the settlement request, and then a fee of one yuan that actually needs to be paid by the user B is calculated based on a fee of three yuan that needs to be paid by the user B and the two-yuan cash red envelope. In such case, one yuan is deducted from an account of the user B and transferred to an account corresponding to the shared bicycle promotion campaign, and finally the resource status of the used two-yuan cash red envelope is marked as a used state.

It should be noted that, in the above-mentioned stake resource write-off process, to ensure validity of write-off, settlement processing is performed first, and then write-off is performed when the settlement succeeds. In addition, to ensure effective use of the stake resource in the settlement process, resource write-off can alternatively be performed by using the following steps: if it is detected that the sharing user or the shared user submits a service request for a recommended item corresponding to the stake resource, querying a resource status of the stake resource; if the resource status is an unused state, sending a resource reminder to the sharing user or the target user; sending a write-off request to a stake platform based on a settlement request that is based on the stake resource and that is submitted by the sharing user or the target user; marking, by the stake platform, a resource status of the stake resource as a used state based on the write-off request, and sending a resource settlement amount and a write-off result of the stake resource to a server; and determining, by the server, an actual settlement amount by using the resource settlement amount and the settlement amount in the settlement request based on the write-off result, and performing, by a payment platform, fund transfer based on the actual settlement amount. To be specific, resource write-off is performed before settlement processing, and if the write-off fails, the settlement fails.

The following further describes the stake sharing processing method provided in these embodiments by using an example in which the stake sharing processing method provided in these embodiments is applied to a multi-user sharing scenario. Referring to FIG. 2, the stake sharing processing method applied to the multi-user sharing scenario specifically includes step S202 to step S216.

Step S202: Establish a stake relationship between a sharing user and a stake resource based on a pickup request of the sharing user for a stake resource of a shared travel service.

Step S204: Perform credibility verification on at least one shared user based on a sharing request of the sharing user for sharing the stake resource with the at least one shared user.

Step S206: After the shared user passing the credibility verification is obtained, determine whether a resource parameter of the stake resource meets a corresponding sharing condition. If the resource parameter of the stake resource meets the corresponding sharing condition, step S208 is performed. If the resource parameter of the stake resource does not meet the corresponding sharing condition, a sharing failure reminder is sent to the sharing user.

Step S208: Add the shared user passing the credibility verification to the stake relationship between the sharing user and the stake resource.

Step S210: If a service request submitted by the sharing user or the shared user for the shared travel service is detected, query a resource status of the stake resource.

Step S212: If the resource status is an unused state, send a resource reminder to the sharing user or the shared user.

Step S214: Perform settlement processing based on a settlement request that is submitted by the sharing user or the shared user based on the stake resource.

Step S216: When the settlement succeeds, mark the resource status of the stake resource as a used state.

In addition, alternatively, when the settlement request is received, the resource status of the stake resource can be first marked as a used state, and then settlement processing is performed based on the stake resource.

In conclusion, according to the stake sharing processing method provided in these embodiments, first, a sharing request of a sharing user for sharing a stake resource with at least one shared user is obtained; then, credibility verification is performed on the at least one shared user based on the sharing request to obtain a user set of a target user passing the verification; and then, whether a resource parameter of the stake resource meets a corresponding sharing condition is determined; and if the resource parameter of the stake resource meets the corresponding sharing condition, the target user is added to a stake relationship between the sharing user and the stake resource, so that the target user obtains a resource permission of the stake resource, thereby improving usage of the stake resource.

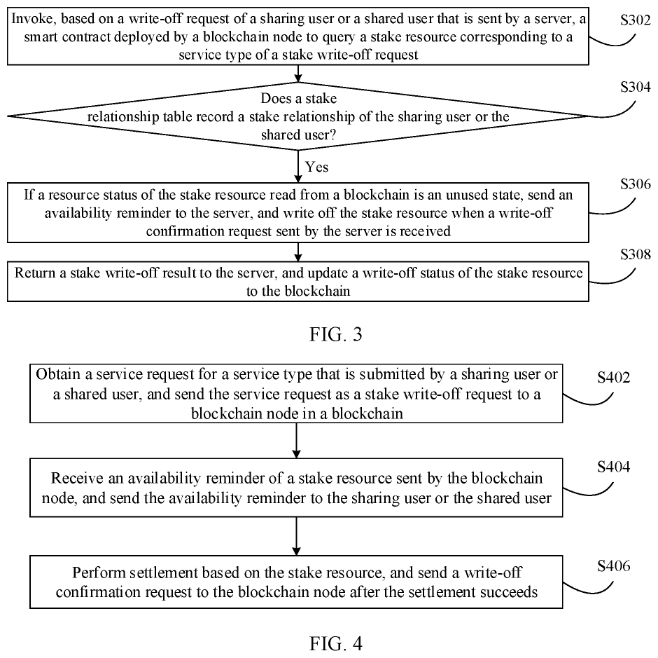

This specification provides some embodiments of a blockchain-based stake write-off processing method. FIG. 3 is a processing flowchart of a blockchain-based stake write-off processing method according to these embodiments.

The blockchain-based stake write-off processing method provided in these embodiments is applied to a blockchain node in a blockchain. The method specifically includes step S302 to step S308.

Step S302: Invoke, based on a write-off request of a sharing user or a shared user that is sent by a server, a smart contract deployed by the blockchain node to query a stake resource corresponding to a service type of a stake write-off request.

The blockchain is used to store a stake relationship table and a resource status of a stake resource, and a stake relationship in the stake relationship table is created after the stake resource is picked up, and is updated after the stake resource is shared. In these embodiments, the sharing user includes a user who picks up a stake resource and shares the obtained stake resource with another user, and the another user with whom the stake resource is shared is the shared user. The stake resource includes an object that is provided by a recommended item to a user and that has economic value or other dimension value, such as a cash red envelope, a coupon, and a periodic card. It should be noted that after picking up a stake resource, the user can view and use the stake resource. In addition, the stake resource can be distributed to a user account, so that the user can use the stake resource in a specific scenario or channel. The recommended item is a service item that distributes a stake resource to a user to increase a participation level of the user, such as a public transportation travel promotion campaign or a shared vehicle travel promotion campaign.

In practice, a user who picks up a stake resource usually does not use the stake resource, but a user who needs to use the stake resource fails to pick up the related stake resource for various reasons, affecting usage of the stake resource. According to the blockchain-based stake write-off processing method provided in these embodiments, after the sharing user shares the stake resource with the shared user, the sharing user or the shared user submits a resource write-off request. In some optional implementations provided in these embodiments, a stake relationship in a stake relationship table stored in the blockchain is created by using the following method: performing credibility verification on the sharing user based on an access request of the sharing user for the service type; if the verification succeeds, sending a recommended stake resource to the sharing user, where the recommended stake resource includes the stake resource; and establishing a stake relationship between the sharing user and the stake resource based on a pickup request of the sharing user for the stake resource.

Specifically, when the sharing user accesses the recommended item, the server performs credibility verification on the sharing user. When the verification succeeds, the server queries at least one corresponding recommended stake resource from a stake platform based on an item identifier of the recommended item, and displays a resource label of the recommended stake resource to the sharing user. When the sharing user submits a pickup request for any one or more recommended stake resources, the server establishes a stake relationship between the sharing user and the recommended stake resource that needs to be picked up. After the stake relationship is established, the server sends the stake relationship to the blockchain node, so that the blockchain node records the stake relationship in the stake relationship table and uploads the stake relationship table to the blockchain for storage.

In addition, alternatively, when detecting that the sharing user accesses the recommended item, the server can perform credibility verification on the sharing user, and send a user identifier of the sharing user and a resource label of the stake resource to the blockchain node when the verification succeeds. The blockchain node invokes the deployed smart contract to establish the stake relationship between the sharing user and the stake resource, records the stake relationship in the stake relationship table, and uploads the stake relationship table to the blockchain for storage.

During specific implementation, after picking up the recommended stake resource, the sharing user can share a part or a whole of the obtained recommended stake resource. When sharing the stake resource, the sharing user needs to select a shared user. To improve security of a stake resource in a stake sharing process, the stake resource can be shared with the shared user by the sharing user only when the shared user passes the credibility verification. Therefore, when at least one shared user is submitted by the sharing user, the stake resource is shared with the shared user passing the credibility verification. When credibility verification is performed on the shared user and the verification succeeds, the stake relationship in the stake relationship table is updated. In some optional implementations provided in these embodiments, the stake relationship is updated by using the following method: obtaining a sharing request of a sharing user for sharing a stake resource with at least one shared user; performing credibility verification on the at least one shared user based on the sharing request, to obtain a user set of the shared user passing the verification; determining whether a resource parameter of the stake resource meets a corresponding sharing condition; and if the resource parameter of the stake resource meets the corresponding sharing condition, adding the shared user to a stake relationship between the sharing user and the stake resource, so as to update the stake relationship.

Specifically, the shared user is added to the stake relationship between the sharing user and the stake resource, so that the shared user obtains the resource permission of the stake resource. After obtaining the resource permission, the shared user can view and use the stake resource in the account. To improve security of a stake resource in a stake sharing process, the stake resource can be shared with the shared user by the sharing user only when the shared user passes the credibility verification. Therefore, when at least one shared user is submitted by the sharing user, the stake resource is shared with the shared user passing the credibility verification.

After performing credibility verification on the at least one shared user based on the sharing request, and obtaining a user set of the shared user passing verification, the server determines whether the resource parameter of the stake resource meets the corresponding sharing condition. If the resource parameter of the stake resource meets the corresponding sharing condition, the server adds the shared user to the stake relationship between the sharing user and the stake resource, and then sends the updated stake relationship to the blockchain node. The blockchain node updates the stake relationship in the stake relationship table based on the stake relationship. The resource parameter includes a resource type, a sharing time, and/or a resource status. In addition, the resource parameter may further include an amount threshold for the stake resource, and the like. The resource parameter is determined based on actual service needs, which is not limited in these embodiments.

In addition, in the process of updating the stake relationship, when receiving a sharing request submitted by the sharing user, the server performs credibility verification based on a user identifier of the shared user in the sharing request, and sends shared information carried in the sharing request to the blockchain node when the verification succeeds. After receiving the shared information, the blockchain node invokes a smart contract deployed by the blockchain node to determine whether the resource parameter of the stake resource meets a corresponding sharing condition. The determining whether the resource parameter of the stake resource meets a corresponding sharing condition is implemented mainly by using the following method: determining whether the resource type of the stake resource is a shareable resource type, determining whether the sharing time is in a sharing time interval, and/or determining whether the resource status of the stake resource is an unused state. In addition, it can be further determined whether a resource amount of the stake resource exceeds the amount threshold. Specifically, the above-mentioned determining may be determining of all the above-mentioned conditions, or may be determining of any one or more of the above-mentioned conditions. If it is determined that the resource parameter meets the corresponding sharing condition, a sharing success result is sent to the server, and the shared user is added to the stake relationship between the sharing user and the stake resource, so as to update the stake relationship in the stake relationship table. After receiving the sharing success result, the server sends the resource label of the stake resource to the sharing user and the shared user.

It should be noted that, after picking up the recommended stake resource, the sharing user can share a part or a whole of the obtained recommended stake resource. When sharing the stake resource, the sharing user needs to select a shared user. To reduce a procedure that the sharing user needs to perform when sharing the stake resource, and to improve sharing experience of the sharing user, the sharing user can set a default shared user in advance. If the user has set a default shared user in advance, when the sharing user triggers a sharing control of the stake resource, by default, the stake resource is shared with the default shared user set by the sharing user, and the sharing user does not need to select a shared user again. If the sharing user does not set a default shared user, when the sharing user triggers the sharing control of the stake resource, the sharing user needs to select and submit a shared user. The shared user is obtained by using the following method: when it is detected that the sharing user triggers a sharing control of the stake resource, querying whether the sharing user sets a default shared user; if the sharing user sets the default shared user, determining the default shared user as the at least one shared user; if the sharing user sets no default shared user, generating a user selection page based on a friend list of the sharing user; and when it is detected that the sharing user triggers a sharing confirmation control configured on the user selection page, determining that at least one user selected by the sharing user by using the user selection page, and/or at least one user queried and selected by the sharing user by using the user selection page is the at least one shared user. In addition, sharing failure may be caused by different resource types, different sharing times, other factors, or the like. Therefore, to increase a perception degree of a sharing user for a sharing failure cause, in some optional implementations provided in these embodiments, if an execution result after performing a step of determining whether a resource parameter of the stake resource meets a corresponding sharing condition is that the resource parameter of the stake resource does not meet the corresponding sharing condition, the following operations are performed: reading a sharing failure cause based on a determining result; and sending a sharing failure reminder to the sharing user based on the sharing failure cause.

Specifically, when it is detected that the sharing user triggers a sharing control of the stake resource, whether the sharing user sets a default shared user is queried. If the sharing user sets the default shared user, the default shared user is used as the shared user. If the sharing user sets no default shared user, a user selection page is generated based on a friend list of the sharing user, and a friend user selected by the sharing user by using the user selection page or a non-friend user queried and selected by the sharing user is used as the shared user.

Step S304: Detect whether the stake relationship table records a stake relationship of the sharing user or the shared user.

During specific implementation, after the corresponding stake resource is determined, it is queried whether the user submitting the write-off request has a stake relationship with the stake resource. If the user submitting the write-off request has a stake relationship with the stake resource, it indicates that the user can use the stake resource. If the user submitting the write-off request has no stake relationship with the stake resource, the user cannot use the stake resource. After it is identified that there is a stake relationship, a resource status of the stake resource is queried from the blockchain. If the resource status is an unused state, an availability reminder of the stake resource is sent to the server. The server displays a resource label of the stake resource to the sharing user or the shared user based on the availability reminder.

In addition, if there are a plurality of stake resources, to increase a perception degree of use statuses of the stake resources, in some optional implementations provided in these embodiments, the availability reminder is sent to the user by using the following method: reading the resource status of the stake resource from the blockchain to obtain a remaining stake resource whose resource status is an unused state; and sending the availability reminder to the server based on a quantity of remaining stake resources.

Step S306: Send an availability reminder to the server, and write off the stake resource when a write-off confirmation request sent by the server is received.

During specific implementation, after the availability reminder is sent to the server, the server performs settlement based on the stake resource, and sends a write-off confirmation request to the blockchain node after the settlement succeeds. Specifically, the server performs settlement processing based on a settlement request that is based on the stake resource and that is submitted by the sharing user or the target user, and sends a write-off confirmation request to the blockchain node when the settlement succeeds. The blockchain marks the resource status of the stake resource as a used state based on the write-off confirmation request.

Step S308: Return a stake write-off result to the server, and update a write-off status of the stake resource to the blockchain.

During specific implementation, a write-off result is returned to the server, and the server sends a write-off reminder to the sharing user or the shared user based on the write-off result. The blockchain node uploads the updated status of the stake resource to the blockchain for storage. Specifically, after the availability reminder is sent to the server, the server performs settlement based on the stake resource, and sends a write-off confirmation request to the blockchain node after the settlement succeeds. Specifically, the server performs settlement processing based on a settlement request that is based on the stake resource and that is submitted by the sharing user or the target user, and sends a write-off confirmation request to the blockchain node when the settlement succeeds. The blockchain marks the resource status of the stake resource as a used state based on the write-off confirmation request. A stake write-off result is returned to the server, and a write-off status of the stake resource is updated to the blockchain. A write-off result is returned to the server, and the server sends a write-off reminder to the sharing user or the shared user based on the write-off result. The blockchain node uploads the updated status of the stake resource to the blockchain for storage.

It should be noted that, in the above-mentioned stake resource write-off process, to ensure validity of write-off, settlement processing is performed first, and then write-off is performed when the settlement succeeds. In addition, to ensure effective use of the stake resource in the settlement process, resource write-off can alternatively be performed by using the following steps: if the server detects that the sharing user or the shared user submits a service request for a recommended item corresponding to the stake resource, the server sends the service request to the blockchain node; the blockchain node queries a resource status of the stake resource; if the resource status is an unused state, the blockchain node sends a resource reminder to the server, so that the server sends the resource reminder to the sharing user or the shared user; the server sends a write-off request to the blockchain node based on a settlement request that is based on the stake resource and that is submitted by the sharing user or the shared user; the blockchain node marks a resource status of the stake resource as a used state based on the write-off request, and sends a resource settlement amount and a write-off result of the stake resource to the server; and the server determines an actual settlement amount by using the resource settlement amount and the settlement amount in the settlement request based on the write-off result, and a payment platform performs fund transfer based on the actual settlement amount. To be specific, resource write-off is performed before settlement processing, and if the write-off fails, the settlement fails.

In addition, both the sharing user and the shared user can view and use the stake resource. To increase a perception degree of a use status of the stake resource, when the sharing user or the shared user views the stake resource, the resource label is displayed by using the following method: if it is detected that the sharing user or the shared user submits an access request for the stake resource, querying a resource status of the stake resource; and displaying a resource label of the stake resource to the sharing user or the shared user based on the resource status.

Specifically, when the sharing user or the shared user accesses the stake resource, the resource status of the stake resource is queried. If the resource status of the stake resource is a used state, a resource label that carries a used mark is displayed to the sharing user or the shared user. If the resource status is an unused state, a resource label that carries an available mark is displayed to the sharing user or the shared user. After receiving the access request of the sharing user or the shared user for the stake resource, the server sends the access request to the blockchain node. The blockchain node queries the resource status of the stake resource from the blockchain based on the access request, and sends the resource status to the server. The server displays the resource label to the sharing user or the shared user based on the resource status. For example, a resource label whose resource status is a used state is set to be viewable only and not accessible, and a resource label whose resource status is an unused state is set to be viewable or accessible.

This specification provides some embodiments of another blockchain-based stake write-off processing method. FIG. 4 is a processing flowchart of a blockchain-based stake write-off processing method according to these embodiments.

The blockchain-based stake write-off processing method provided in these embodiments is applied to a server. The method specifically includes step S402 to step S406.

The blockchain-based stake write-off processing method that is applied to the server and that is provided in these embodiments cooperates with the above-mentioned blockchain-based stake write-off processing method applied to the blockchain node in the blockchain during execution. Therefore, in a process of reading the blockchain-based stake write-off processing method provided in these embodiments, references can be made to some embodiments of the above-mentioned blockchain-based stake write-off processing method applied to the blockchain node in the blockchain.

Step S402: Obtain a service request for a service type that is submitted by a sharing user or a shared user, and send the service request as a stake write-off request to a blockchain node in a blockchain.

The blockchain is used to store a stake relationship table and a resource status of a stake resource, and a stake relationship in the stake relationship table is created after the stake resource is picked up, and is updated after the stake resource is shared. In these embodiments, the sharing user includes a user who picks up a stake resource and shares the obtained stake resource with another user, and the another user with whom the stake resource is shared is the shared user. The stake resource includes an object that is provided by a recommended item to a user and that has economic value or other dimension value, such as a cash red envelope, a coupon, and a periodic card. It should be noted that after picking up a stake resource, the user can view and use the stake resource. In addition, the stake resource can be distributed to a user account, so that the user can use the stake resource in a specific scenario or channel. The recommended item is a service item that distributes a stake resource to a user to increase a participation level of the user, such as a public transportation travel promotion campaign or a shared vehicle travel promotion campaign.

In practice, a user who picks up a stake resource usually does not use the stake resource, but a user who needs to use the stake resource fails to pick up the related stake resource for various reasons, affecting usage of the stake resource. According to the blockchain-based stake write-off processing method provided in these embodiments, after the sharing user shares the stake resource with the shared user, the sharing user or the shared user submits a resource write-off request. In some optional implementations provided in these embodiments, a stake relationship in a stake relationship table stored in the blockchain is created by using the following method: performing credibility verification on the sharing user based on an access request of the sharing user for the service type; if the verification succeeds, sending a recommended stake resource to the sharing user, where the recommended stake resource includes the stake resource; and establishing a stake relationship between the sharing user and the stake resource based on a pickup request of the sharing user for the stake resource.

Specifically, when the sharing user accesses the recommended item, the server performs credibility verification on the sharing user. When the verification succeeds, the server queries at least one corresponding recommended stake resource from a stake platform based on an item identifier of the recommended item, and displays a resource label of the recommended stake resource to the sharing user. When the sharing user submits a pickup request for any one or more recommended stake resources, the server establishes a stake relationship between the sharing user and the recommended stake resource that needs to be picked up. After the stake relationship is established, the server sends the stake relationship to the blockchain node, so that the blockchain node records the stake relationship in the stake relationship table and uploads the stake relationship table to the blockchain for storage.

In addition, alternatively, when detecting that the sharing user accesses the recommended item, the server can perform credibility verification on the sharing user, and send a user identifier of the sharing user and a resource label of the stake resource to the blockchain node when the verification succeeds. The blockchain node invokes the deployed smart contract to establish the stake relationship between the sharing user and the stake resource, records the stake relationship in the stake relationship table, and uploads the stake relationship table to the blockchain for storage.

During specific implementation, after picking up the recommended stake resource, the sharing user can share a part or a whole of the obtained recommended stake resource. When sharing the stake resource, the sharing user needs to select a shared user. To improve security of a stake resource in a stake sharing process, the stake resource can be shared with the shared user by the sharing user only when the shared user passes the credibility verification. Therefore, when at least one shared user is submitted by the sharing user, the stake resource is shared with the shared user passing the credibility verification. When credibility verification is performed on the shared user and the verification succeeds, the stake relationship in the stake relationship table is updated. In some optional implementations provided in these embodiments, the stake relationship is updated by using the following method: obtaining a sharing request of a sharing user for sharing a stake resource with at least one shared user; performing credibility verification on the at least one shared user based on the sharing request, to obtain a user set of the shared user passing the verification; determining whether a resource parameter of the stake resource meets a corresponding sharing condition; and if the resource parameter of the stake resource meets the corresponding sharing condition, adding the shared user to a stake relationship between the sharing user and the stake resource, so as to update the stake relationship.

Specifically, the shared user is added to the stake relationship between the sharing user and the stake resource, so that the shared user obtains the resource permission of the stake resource. After obtaining the resource permission, the shared user can view and use the stake resource in the account. To improve security of a stake resource in a stake sharing process, the stake resource can be shared with the shared user by the sharing user only when the shared user passes the credibility verification. Therefore, when at least one shared user is submitted by the sharing user, the stake resource is shared with the shared user passing the credibility verification.

After performing credibility verification on the at least one shared user based on the sharing request, and obtaining a user set of the shared user passing verification, the server determines whether the resource parameter of the stake resource meets the corresponding sharing condition. If the resource parameter of the stake resource meets the corresponding sharing condition, the server adds the shared user to the stake relationship between the sharing user and the stake resource, and then sends the updated stake relationship to the blockchain node. The blockchain node updates the stake relationship in the stake relationship table based on the stake relationship. The resource parameter includes a resource type, a sharing time, and/or a resource status. In addition, the resource parameter may further include an amount threshold for the stake resource, and the like. The resource parameter is determined based on actual service needs, which is not limited in these embodiments.

In addition, in the process of updating the stake relationship, when receiving a sharing request submitted by the sharing user, the server performs credibility verification based on a user identifier of the shared user in the sharing request, and sends shared information carried in the sharing request to the blockchain node when the verification succeeds. After receiving the shared information, the blockchain node invokes a smart contract deployed by the blockchain node to determine whether the resource parameter of the stake resource meets a corresponding sharing condition. The determining whether the resource parameter of the stake resource meets a corresponding sharing condition is implemented mainly by using the following method: determining whether the resource type of the stake resource is a shareable resource type, determining whether the sharing time is in a sharing time interval, and/or determining whether the resource status of the stake resource is an unused state. In addition, it can be further determined whether a resource amount of the stake resource exceeds the amount threshold. Specifically, the above-mentioned determining may be determining of all the above-mentioned conditions, or may be determining of any one or more of the above-mentioned conditions. If it is determined that the resource parameter meets the corresponding sharing condition, a sharing success result is sent to the server, and the shared user is added to the stake relationship between the sharing user and the stake resource, so as to update the stake relationship in the stake relationship table. After receiving the sharing success result, the server sends the resource label of the stake resource to the sharing user and the shared user.

It should be noted that, after picking up the recommended stake resource, the sharing user can share a part or a whole of the obtained recommended stake resource. When sharing the stake resource, the sharing user needs to select a shared user. To reduce a procedure that the sharing user needs to perform when sharing the stake resource, and to improve sharing experience of the sharing user, the sharing user can set a default shared user in advance. If the user has set a default shared user in advance, when the sharing user triggers a sharing control of the stake resource, by default, the stake resource is shared with the default shared user set by the sharing user, and the sharing user does not need to select a shared user again. If the sharing user does not set a default shared user, when the sharing user triggers the sharing control of the stake resource, the sharing user needs to select and submit a shared user. The shared user is obtained by using the following method: when it is detected that the sharing user triggers a sharing control of the stake resource, querying whether the sharing user sets a default shared user; if the sharing user sets the default shared user, determining the default shared user as the at least one shared user; if the sharing user sets no default shared user, generating a user selection page based on a friend list of the sharing user; and when it is detected that the sharing user triggers a sharing confirmation control configured on the user selection page, determining that at least one user selected by the sharing user by using the user selection page, and/or at least one user queried and selected by the sharing user by using the user selection page is the at least one shared user. In addition, sharing failure may be caused by different resource types, different sharing times, other factors, or the like. Therefore, to increase a perception degree of a sharing user for a sharing failure cause, in some optional implementations provided in these embodiments, if an execution result after performing a step of determining whether a resource parameter of the stake resource meets a corresponding sharing condition is that the resource parameter of the stake resource does not meet the corresponding sharing condition, the following operations are performed: reading a sharing failure cause based on a determining result; and sending a sharing failure reminder to the sharing user based on the sharing failure cause.

Specifically, when it is detected that the sharing user triggers a sharing control of the stake resource, whether the sharing user sets a default shared user is queried. If the sharing user sets the default shared user, the default shared user is used as the shared user. If the sharing user sets no default shared user, a user selection page is generated based on a friend list of the sharing user, and a friend user selected by the sharing user by using the user selection page or a non-friend user queried and selected by the sharing user is used as the shared user.

Step S404: Receive an availability reminder of a stake resource sent by the blockchain node, and send the availability reminder to the sharing user or the shared user.

During specific implementation, after receiving the write-off request, the blockchain node invokes a smart contract deployed by the blockchain node to query a stake resource corresponding to a service type of the stake write-off request. After determining the corresponding stake resource, the blockchain node queries whether the user submitting the write-off request has a stake relationship with the stake resource. If the user submitting the write-off request has a stake relationship with the stake resource, it indicates that the user can use the stake resource. If the user submitting the write-off request has no stake relationship with the stake resource, the user cannot use the stake resource. After it is identified that there is a stake relationship, a resource status of the stake resource is queried from the blockchain. If the resource status is an unused state, an availability reminder of the stake resource is sent to the server. The server displays a resource label of the stake resource to the sharing user or the shared user based on the availability reminder.

In addition, if there are a plurality of stake resources, to increase a perception degree of use statuses of the stake resources, the blockchain node sends the availability reminder to the user by using the following method: reading the resource status of the stake resource from the blockchain to obtain a remaining stake resource whose resource status is an unused state; and sending the availability reminder to the server based on a quantity of remaining stake resources. The blockchain node sends the availability reminder to the server, and writes off the stake resource when a write-off confirmation request sent by the server is received.

Step S406: Perform settlement based on the stake resource, and send a write-off confirmation request to the blockchain node after the settlement succeeds.

During specific implementation, after the availability reminder is sent to the server, the server performs settlement based on the stake resource, and sends a write-off confirmation request to the blockchain node after the settlement succeeds. Specifically, the server performs settlement processing based on a settlement request that is based on the stake resource and that is submitted by the sharing user or the target user, and sends a write-off confirmation request to the blockchain node when the settlement succeeds. The blockchain marks the resource status of the stake resource as a used state based on the write-off confirmation request. A stake write-off result is returned to the server, and a write-off status of the stake resource is updated to the blockchain. A write-off result is returned to the server, and the server sends a write-off reminder to the sharing user or the shared user based on the write-off result. The blockchain node uploads the updated status of the stake resource to the blockchain for storage.

During the settlement processing, the server specifically performs settlement processing by using the following method: sending a write-off request to the blockchain node based on the settlement request, and obtaining a resource settlement amount of the stake resource from the blockchain node; and determining an actual settlement amount based on the resource settlement amount and a settlement amount in the settlement request, and performing, by a payment platform, fund transfer based on the actual settlement amount, where after the fund transfer succeeds, the payment platform sends a write-off confirmation reminder to the blockchain node, so that the blockchain node marks the resource status of the stake resource as a used state based on the write-off confirmation reminder.

It should be noted that, in the above-mentioned stake resource write-off process, to ensure validity of write-off, settlement processing is performed first, and then write-off is performed when the settlement succeeds. In addition, to ensure effective use of the stake resource in the settlement process, resource write-off can alternatively be performed by using the following steps: if the server detects that the sharing user or the shared user submits a service request for a recommended item corresponding to the stake resource, the server sends the service request to the blockchain node; the blockchain node queries a resource status of the stake resource; if the resource status is an unused state, the blockchain node sends a resource reminder to the server, so that the server sends the resource reminder to the sharing user or the shared user; the server sends a write-off request to the blockchain node based on a settlement request that is based on the stake resource and that is submitted by the sharing user or the shared user; the blockchain node marks a resource status of the stake resource as a used state based on the write-off request, and sends a resource settlement amount and a write-off result of the stake resource to the server; and the server determines an actual settlement amount by using the resource settlement amount and the settlement amount in the settlement request based on the write-off result, and a payment platform performs fund transfer based on the actual settlement amount. To be specific, resource write-off is performed before settlement processing, and if the write-off fails, the settlement fails.

In addition, both the sharing user and the shared user can view and use the stake resource. To increase a perception degree of a use status of the stake resource, when the sharing user or the shared user views the stake resource, the resource label is displayed by using the following method: if it is detected that the sharing user or the shared user submits an access request for the stake resource, querying a resource status of the stake resource; and displaying a resource label of the stake resource to the sharing user or the shared user based on the resource status.

Specifically, when the sharing user or the shared user accesses the stake resource, the resource status of the stake resource is queried. If the resource status of the stake resource is a used state, a resource label that carries a used mark is displayed to the sharing user or the shared user. If the resource status is an unused state, a resource label that carries an available mark is displayed to the sharing user or the shared user. After receiving the access request of the sharing user or the shared user for the stake resource, the server sends the access request to the blockchain node. The blockchain node queries the resource status of the stake resource from the blockchain based on the access request, and sends the resource status to the server. The server displays the resource label to the sharing user or the shared user based on the resource status. For example, a resource label whose resource status is a used state is set to be viewable only and not accessible, and a resource label whose resource status is an unused state is set to be viewable or accessible.

Some embodiments of a stake sharing processing apparatus provided in this specification are as follows: Some embodiments described above provide a stake sharing processing method. Correspondingly, a stake sharing processing apparatus is further provided, which is described below with reference to accompanying drawings.

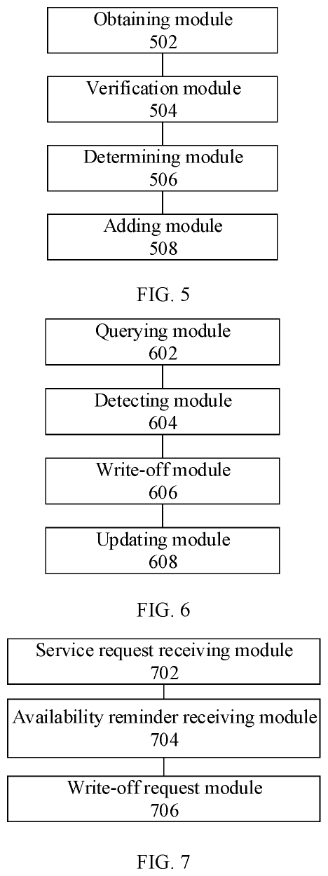

FIG. 5 is a schematic diagram of a stake sharing processing apparatus according to some embodiments.

Some apparatus embodiments are briefly described because they correspond to some method embodiments. For related parts, references can be made to the corresponding descriptions in the method embodiments provided above. Some apparatus embodiments described below are merely examples.

These embodiments provide a stake sharing processing apparatus, including: an obtaining module 502, configured to obtain a sharing request of a sharing user for sharing a stake resource with at least one shared user; a verification module 504, configured to perform credibility verification on the at least one shared user based on the sharing request, to obtain a user set of a target user passing the verification; a determining module 506, configured to determine whether a resource parameter of the stake resource meets a corresponding sharing condition; and if the resource parameter of the stake resource meets the corresponding sharing condition, an adding module 508 is run, where the adding module 508 is configured to add the target user to a stake relationship between the sharing user and the stake resource, so that the target user obtains a resource permission of the stake resource.

Some embodiments of a blockchain-based stake write-off processing apparatus provided in this specification are as follows: Some embodiments described above provide a blockchain-based stake write-off processing method, which is applied to a blockchain node in a blockchain. Correspondingly, a blockchain-based stake write-off processing apparatus is further provided, which runs on a blockchain node in a blockchain, and is described below with reference to accompanying drawings.

FIG. 6 is a schematic diagram of a blockchain-based stake write-off processing apparatus according to some embodiments.

Some apparatus embodiments are briefly described because they correspond to some method embodiments. For related parts, references can be made to the corresponding descriptions in the method embodiments provided above. Some apparatus embodiments described below are merely examples.

These embodiments provide a blockchain-based stake write-off processing apparatus, including: a querying module 602, configured to invoke, based on a write-off request of a sharing user or a shared user that is sent by a server, a smart contract deployed by the blockchain node to query a stake resource corresponding to a service type of a stake write-off request; a detecting module 604, configured to detect whether the stake relationship table records a stake relationship of the sharing user or the shared user; if the stake relationship table records the stake relationship of the sharing user or the shared user, and if the resource status of the stake resource read from the blockchain is an unused state, a write-off module 606 is run, where the write-off module 606 is configured to send an availability reminder to the server, and write off the stake resource when a write-off confirmation request sent by the server is received; and an updating module 608, configured to return a stake write-off result to the server, and update a write-off status of the stake resource to the blockchain.

Some embodiments of another blockchain-based stake write-off processing apparatus provided in this specification are as follows: Some embodiments described above provide a blockchain-based stake write-off processing method, which is applied to a server. Correspondingly, a blockchain-based stake write-off processing apparatus is further provided, which runs on a server, and is described below with reference to accompanying drawings.

FIG. 7 is a schematic diagram of a blockchain-based stake write-off processing apparatus according to some embodiments.

Some apparatus embodiments are briefly described because they correspond to some method embodiments. For related parts, references can be made to the corresponding descriptions in the method embodiments provided above. Some apparatus embodiments described below are merely examples.

These embodiments provide a blockchain-based stake write-off processing apparatus, including: a service request receiving module 702, configured to obtain a service request for a service type that is submitted by a sharing user or a shared user, and send the service request as a stake write-off request to a blockchain node in a blockchain; an availability reminder receiving module 704, configured to receive an availability reminder of a stake resource sent by the blockchain node, and send the availability reminder to the sharing user or the shared user; and a write-off request module 706, configured to perform settlement based on the stake resource, and send a write-off confirmation request to the blockchain node after the settlement succeeds.

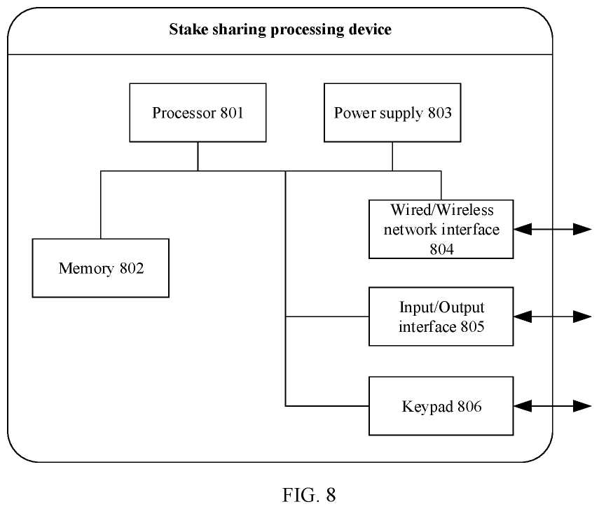

Some embodiments of a stake sharing processing device provided in this specification are as follows: Corresponding to the stake sharing processing method described above, based on the same technical concept, one or more embodiments of this specification further provide a stake sharing processing device. The stake sharing processing device is configured to perform the stake sharing processing method provided above. FIG. 8 is a schematic structural diagram of a stake sharing processing device according to one or more embodiments of this specification.

The stake sharing processing device provided in these embodiments includes: As shown in FIG. 8, the stake sharing processing device may differ greatly due to a difference in configuration or performance, and may include one or more processors 801 and one or more memories 802. The memory 802 can store one or more applications or data. The memory 802 may be a temporary storage or a persistent storage. The application stored in the memory 802 may include one or more modules (not shown in the figure), and each module may include a series of computer-executable instructions in the stake sharing processing device. Still further, the processor 801 can be configured to communicate with the memory 802 to execute a series of computer-executable instructions in the memory 802 on the stake sharing processing device. The stake sharing processing device may further include one or more power supplies 803, one or more wired or wireless network interfaces 804, one or more input/output interfaces 805, one or more keypads 806, etc.

In some specific embodiments, the stake sharing processing device includes a memory and one or more programs. The one or more programs are stored in the memory, and the one or more programs may include one or more modules, and each module may include a series of computer-executable instructions in the stake sharing processing device. One or more processors are configured to execute the computer-executable instructions included in the one or more programs to perform the following operations: obtaining a sharing request of a sharing user for sharing a stake resource with at least one shared user; performing credibility verification on the at least one shared user based on the sharing request, to obtain a user set of a target user passing the verification; determining whether a resource parameter of the stake resource meets a corresponding sharing condition; and if the resource parameter of the stake resource meets the corresponding sharing condition, adding the target user to a stake relationship between the sharing user and the stake resource, so that the target user obtains a resource permission of the stake resource.

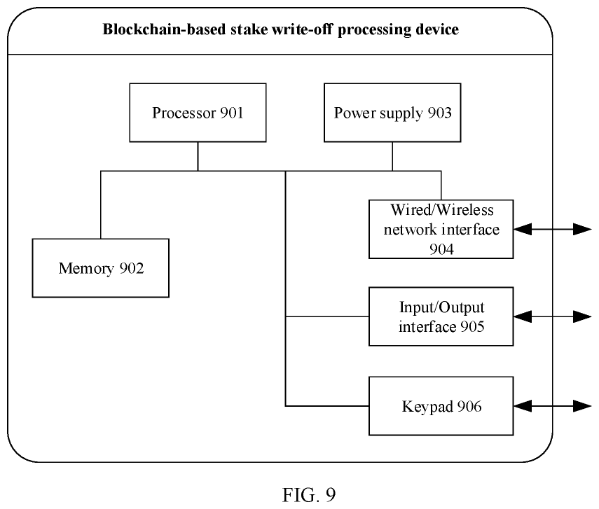

Some embodiments of a blockchain-based stake write-off processing device provided in this specification are as follows: Corresponding to the blockchain-based stake write-off processing method described above, which is applied to a blockchain node corresponding to a server in a blockchain, based on the same technical concept, one or more embodiments of this specification further provide a blockchain-based stake write-off processing device. The blockchain-based stake write-off processing device is configured to perform the blockchain-based stake write-off processing method provided above. FIG. 9 is a schematic structural diagram of a blockchain-based stake write-off processing device according to one or more embodiments of this specification.

The blockchain-based stake write-off processing device provided in these embodiments is applied to a blockchain node in a blockchain and includes: As shown in FIG. 9, the blockchain-based stake write-off processing device may differ greatly due to a difference in configuration or performance, and may include one or more processors 901 and one or more memories 902. The memory 902 can store one or more applications or data. The memory 902 may be a temporary storage or a persistent storage. The application stored in the memory 902 may include one or more modules (not shown in the figure), and each module may include a series of computer-executable instructions in the blockchain-based stake write-off processing device. Still further, the processor 901 can be configured to communicate with the memory 902 to execute a series of computer-executable instructions in the memory 902 on the blockchain-based stake write-off processing device. The blockchain-based stake write-off processing device may further include one or more power supplies 903, one or more wired or wireless network interfaces 904, one or more input/output interfaces 905, one or more keypads 906, etc.

In some specific embodiments, the blockchain-based stake write-off processing device includes a memory and one or more programs. The one or more programs are stored in the memory, and the one or more programs may include one or more modules, and each module may include a series of computer-executable instructions in the blockchain-based stake write-off processing device. One or more processors are configured to execute the computer-executable instructions included in the one or more programs to perform the following operations: invoking, based on a write-off request of a sharing user or a shared user that is sent by a server, a smart contract deployed by the blockchain node to query a stake resource corresponding to a service type of a stake write-off request; detecting whether the stake relationship table records a stake relationship of the sharing user or the shared user; if the stake relationship table records the stake relationship of the sharing user or the shared user, and if the resource status of the stake resource read from the blockchain is an unused state, sending an availability reminder to the server, and writing off the stake resource when a write-off confirmation request sent by the server is received; and returning a stake write-off result to the server, and updating a write-off status of the stake resource to the blockchain.

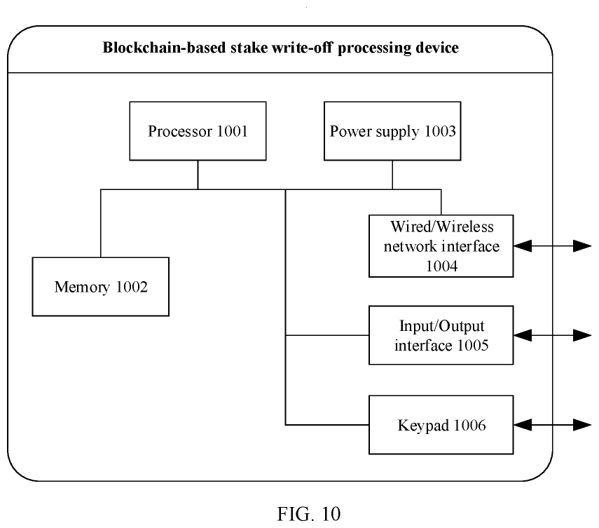

Some embodiments of another blockchain-based stake write-off processing device provided in this specification are as follows: Corresponding to the blockchain-based stake write-off processing method described above, which is applied to a server, based on the same technical concept, one or more embodiments of this specification further provide a blockchain-based stake write-off processing device. The blockchain-based stake write-off processing device is configured to perform the blockchain-based stake write-off processing method provided above. FIG. 10 is a schematic structural diagram of a blockchain-based stake write-off processing device according to one or more embodiments of this specification.

The blockchain-based stake write-off processing device provided in these embodiments is applied to a server and includes: As shown in FIG. 10, the blockchain-based stake write-off processing device may differ greatly due to a difference in configuration or performance, and may include one or more processors 1001 and one or more memories 1002. The memory 1002 can store one or more applications or data. The memory 1002 may be a temporary storage or a persistent storage. The application stored in the memory 1002 may include one or more modules (not shown in the figure), and each module may include a series of computer-executable instructions in the blockchain-based stake write-off processing device. Still further, the processor 1001 can be configured to communicate with the memory 1002 to execute a series of computer-executable instructions in the memory 1002 on the blockchain-based stake write-off processing device. The blockchain-based stake write-off processing device may further include one or more power supplies 1003, one or more wired or wireless network interfaces 1004, one or more input/output interfaces 1005, one or more keypads 1006, etc.

In some specific embodiments, the blockchain-based stake write-off processing device includes a memory and one or more programs. The one or more programs are stored in the memory, and the one or more programs may include one or more modules, and each module may include a series of computer-executable instructions in the blockchain-based stake write-off processing device. One or more processors are configured to execute the computer-executable instructions included in the one or more programs to perform the following operations: obtaining a service request for a service type that is submitted by a sharing user or a shared user, and sending the service request as a stake write-off request to a blockchain node in a blockchain; receiving an availability reminder of a stake resource sent by the blockchain node, and sending the availability reminder to the sharing user or the shared user; and performing settlement based on the stake resource, and sending a write-off confirmation request to the blockchain node after the settlement succeeds.

Some embodiments of a storage medium provided in this specification are as follows: Corresponding to the stake sharing processing method described above, based on the same technical concept, one or more embodiments of this specification further provide a storage medium.

The storage medium provided in these embodiments is configured to store a computer-executable instruction, where the computer-executable instruction is executed to implement the following procedure: obtaining a sharing request of a sharing user for sharing a stake resource with at least one shared user; performing credibility verification on the at least one shared user based on the sharing request, to obtain a user set of a target user passing the verification; determining whether a resource parameter of the stake resource meets a corresponding sharing condition; and if the resource parameter of the stake resource meets the corresponding sharing condition, adding the target user to a stake relationship between the sharing user and the stake resource, so that the target user obtains a resource permission of the stake resource.

It should be noted that the embodiments of the storage medium in this specification are based on the same inventive concept as the embodiments of the stake sharing processing method in this specification. Therefore, for specific implementation of the embodiments of the storage medium, references can be made to the above-mentioned implementation of the corresponding method, and repeated parts are omitted for simplicity.

Some embodiments of a second storage medium provided in this specification are as follows: Corresponding to the blockchain-based stake write-off processing method described above, which is applied to a blockchain node corresponding to a server in a blockchain, based on the same technical concept, one or more embodiments of this specification further provide a storage medium.

The storage medium provided in these embodiments is configured to store a computer-executable instruction, where the computer-executable instruction is executed to implement the following procedure: invoking, based on a write-off request of a sharing user or a shared user that is sent by a server, a smart contract deployed by the blockchain node to query a stake resource corresponding to a service type of a stake write-off request; detecting whether the stake relationship table records a stake relationship of the sharing user or the shared user; if the stake relationship table records the stake relationship of the sharing user or the shared user, and if the resource status of the stake resource read from the blockchain is an unused state, sending an availability reminder to the server, and writing off the stake resource when a write-off confirmation request sent by the server is received; and returning a stake write-off result to the server, and updating a write-off status of the stake resource to the blockchain.

It should be noted that the embodiments of the storage medium in this specification are based on the same inventive concept as the embodiments of the blockchain-based stake write-off processing method in this specification. Therefore, for specific implementation of the embodiments of the storage medium, references can be made to the above-mentioned implementation of the corresponding method, and repeated parts are omitted for simplicity.

Some embodiments of a third storage medium provided in this specification are as follows: Corresponding to the blockchain-based stake write-off processing method described above, which is applied to a server, based on the same technical concept, one or more embodiments of this specification further provide a storage medium.

The storage medium provided in these embodiments is configured to store a computer-executable instruction, where the computer-executable instruction is executed to implement the following procedure: obtaining a service request for a service type that is submitted by a sharing user or a shared user, and sending the service request as a stake write-off request to a blockchain node in a blockchain; receiving an availability reminder of a stake resource sent by the blockchain node, and sending the availability reminder to the sharing user or the shared user; and performing settlement based on the stake resource, and sending a write-off confirmation request to the blockchain node after the settlement succeeds.

It should be noted that the embodiments of the storage medium in this specification are based on the same inventive concept as the embodiments of the blockchain-based stake write-off processing method in this specification. Therefore, for specific implementation of the embodiments of the storage medium, references can be made to the above-mentioned implementation of the corresponding method, and repeated parts are omitted for simplicity.

Some specific embodiments of this specification are described above. Other embodiments fall within the scope of the appended claims. In some cases, actions or steps described in the claims can be performed in a sequence different from that in some embodiments and desired results can still be achieved. In addition, processes described in the accompanying drawings do not necessarily need a specific order or a sequential order shown to achieve the desired results. In some implementations, multi-tasking and parallel processing are also possible or may be advantageous.

In the 1930s, whether a technical improvement is a hardware improvement (for example, an improvement to a circuit structure, such as a diode, a transistor, or a switch) or a software improvement (an improvement to a method procedure) can be clearly distinguished. However, as technologies develop, current improvements to many method procedures may be considered as direct improvements to hardware circuit structures. A designer usually programs an improved method procedure into a hardware circuit to obtain a corresponding hardware circuit structure. Therefore, a method procedure can be improved using a hardware entity module. For example, a programmable logic device (PLD) (for example, a field programmable gate array (FPGA)) is such an integrated circuit, and a logical function of the programmable logic device is determined by a user through device programming. The designer performs programming to “integrate” a digital system to a PLD without requesting a chip manufacturer to design and produce an application-specific integrated circuit chip. In addition, at present, instead of manually manufacturing an integrated circuit chip, this type of programming is mostly implemented by using “logic compiler” software. The programming is similar to a software compiler used to develop and write a program. Original code needs to be written in a particular programming language for compilation. The language is referred to as a hardware description language (HDL). There are many HDLs, such as the Advanced Boolean Expression Language (ABEL), the Altera Hardware Description Language (AHDL), Confluence, the Cornell University Programming Language (CUPL), HDCal, the Java Hardware Description Language (JHDL), Lava, Lola, MyHDL, PALASM, and the Ruby Hardware Description Language (RHDL). The very-high-speed integrated circuit hardware description language (VHDL) and Verilog are most commonly used. A person skilled in the art should also understand that a hardware circuit that implements a logical method procedure can be readily obtained once the method procedure is logically programmed by using some described hardware description languages and is programmed into an integrated circuit.

A controller can be implemented by using any appropriate method. For example, the controller may be a microprocessor or a processor, or a computer-readable medium that stores computer-readable program code (such as software or firmware) that can be executed by the microprocessor or the processor, a logic gate, a switch, an application-specific integrated circuit (ASIC), a programmable logic controller, or a built-in microprocessor. Examples of the controller include but are not limited to the following microprocessors: ARC 625D, Atmel AT91SAM, Microchip PIC18F26K20, and Silicone Labs C8051F320. The memory controller can also be implemented as a part of the control logic of the memory. A person skilled in the art also knows that, in addition to implementing the controller by using only the computer-readable program code, logic programming can be performed on method steps to enable the controller to implement the same function in forms of the logic gate, the switch, the application-specific integrated circuit, the programmable logic controller, the embedded microcontroller, etc. Therefore, the controller may be considered as a hardware component, and an apparatus included in the controller for implementing various functions may also be considered as a structure in the hardware component. Alternatively, the apparatus configured to implement various functions may even be considered as both a software module implementing the method and a structure in the hardware component.

The system, apparatus, module, or unit illustrated in the above-mentioned embodiments can be specifically implemented by using a computer chip or an entity, or can be implemented by using a product having a specific function. A typical implementation device is a computer. Specifically, for example, the computer may be a personal computer, a laptop computer, a cellular phone, a camera phone, a smart phone, a personal digital assistant, a media player, a navigation device, an e-mail device, a game console, a tablet computer, a wearable device, or any combination of these devices.

For case of description, the above-mentioned apparatus is described by dividing functions into various units. Certainly, when some embodiments of this specification are implemented, a function of each unit can be implemented in one or more pieces of software and/or hardware.

A person skilled in the art should understand that one or more embodiments of this specification can be provided as methods, systems, or computer program products. Therefore, one or more embodiments of this specification can use a form of hardware only embodiments, software only embodiments, or embodiments with a combination of software and hardware. Moreover, this specification can use a form of a computer program product that is implemented on one or more computer-usable storage media (including but not limited to a disk memory, a CD-ROM, an optical memory, etc.) that include computer-usable program code.

This specification is described with reference to the flowcharts and/or block diagrams of the method, the device (system), and the computer program product according to some embodiments of this specification. It should be understood that computer program instructions can be used to implement each process and/or each block in the flowcharts and/or the block diagrams and a combination of a process and/or a block in the flowcharts and/or the block diagrams. These computer program instructions can be provided for a general-purpose computer, a dedicated computer, an embedded processor, or a processor of another programmable data processing device to generate a machine, so the instructions executed by the computer or the processor of the another programmable data processing device generate an apparatus for implementing a specific function in one or more processes in the flowcharts and/or in one or more blocks in the block diagrams.

These computer program instructions can be stored in a computer-readable memory that can instruct the computer or the another programmable data processing device to work in a specific way, so the instructions stored in the computer-readable memory generate an artifact that includes an instruction apparatus. The instruction apparatus implements a specific function in one or more processes in the flowcharts and/or in one or more blocks in the block diagrams.

These computer program instructions can alternatively be loaded onto the computer or the another programmable data processing device such that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

In a typical configuration, a computing device includes one or more processors (CPUs), one or more input/output interfaces, one or more network interfaces, and one or more memories. The memory may include a non-persistent memory, a random access memory (RAM), a non-volatile memory, and/or another form that are in a computer-readable medium, for example, a read-only memory (ROM) or a flash memory (flash RAM). The memory is an example of the computer-readable medium. The computer-readable medium includes a persistent and a non-persistent, a removable and a non-removable medium, which can implement information storage by using any method or technology. Information may be a computer-readable instruction, a data structure, a program module, or other data. Examples of the computer storage medium include but are not limited to a phase change random access memory (PRAM), a static random access memory (SRAM), a dynamic random access memory (DRAM), another type of RAM, a ROM, an electrically erasable programmable read-only memory (EEPROM), a flash memory or another memory technology, a compact disc read-only memory (CD-ROM), a digital versatile disc (DVD) or another optical storage, a cassette magnetic tape, a magnetic tape/magnetic disk storage, another magnetic storage device, or any other non-transmission medium. The computer storage medium can be configured to store information accessible by a computing device. Based on the definition in this specification, the computer-readable medium does not include transitory media such as a modulated data signal and carrier.

It should be further noted that, the terms “include”, “comprise”, or any other variant thereof are intended to cover a non-exclusive inclusion, so that a process, a method, a product or a device that includes a list of elements not only includes those elements but also includes other elements which are not expressly listed, or further includes elements inherent to such process, method, product or device. Without more constraints, an element preceded by “includes a . . . ” does not preclude the existence of additional identical elements in the process, method, product or device that includes the element.

One or more embodiments of this specification can be described in the general context of computer-executable instructions, for example, a program module. Generally, the program module includes a routine, a program, an object, a component, a data structure, etc. executing a specific task or implementing a specific abstract data type. One or more embodiments of this specification can alternatively be practiced in distributed computing environments. In the distributed computing environments, tasks are performed by remote processing devices connected through a communication network. In the distributed computing environments, the program module can be located in a local and remote computer storage medium including a storage device.

Some embodiments of this specification are described in a progressive way. For same or similar parts of some embodiments, mutual references can be made to the embodiments. Each embodiment focuses on a difference from other embodiments. Particularly, some system embodiments are briefly described because they are basically similar to some method embodiments. For related parts, references can be made to related descriptions in some method embodiments.

The foregoing descriptions are merely some embodiments of this specification and are not intended to limit this specification. A person skilled in the art can make various changes and variations to this specification. Any modification, equivalent replacement, or improvement made without departing from the spirit and principle of this specification shall fall within the scope of the claims in this specification.

1. A stake sharing processing method, comprising:
obtaining a sharing request of a sharing user for sharing a stake resource with at least one shared user;
performing credibility verification on the at least one shared user based on the sharing request, to obtain a user set of a target user passing the verification;
determining whether a resource parameter of the stake resource meets a corresponding sharing condition; and
upon determining that the resource parameter of the stake resource meets the corresponding sharing condition, adding the target user to a stake relationship between the sharing user and the stake resource, so that the target user obtains a resource permission of the stake resource.

2. The stake sharing processing method according to claim 1, further comprising:
upon determining that it is detected that the sharing user or the target user submits an access request for the stake resource, querying a resource status of the stake resource; and
displaying a resource label of the stake resource to the sharing user or the target user based on the resource status.

3. The stake sharing processing method according to claim 1, further comprising:
upon determining that it is detected that the sharing user or the target user submits a service request for a recommended item corresponding to the stake resource, querying a resource status of the stake resource; and
upon determining that the resource status is an unused state, sending a resource reminder to the sharing user or the target user.

4. The stake sharing processing method according to claim 3, after performing an operation of sending a resource reminder to the sharing user or the target user, further comprising:
performing settlement processing based on a settlement request that is based on the stake resource and that is submitted by the sharing user or the target user; and
performing, by a stake platform, resource write-off on the stake resource in a case of settlement success.

5. The stake sharing processing method according to claim 4, wherein the settlement processing comprises:
sending a write-off request to the stake platform based on the settlement request, and obtaining a resource settlement amount of the stake resource from the stake platform; and
determining an actual settlement amount based on the resource settlement amount and a settlement amount in the settlement request, and performing, by a payment platform, fund transfer based on the actual settlement amount, wherein
after the fund transfer succeeds, the payment platform sends a write-off confirmation reminder to the stake platform, so that the stake platform marks the resource status of the stake resource as a used state based on the write-off confirmation reminder.

6. The stake sharing processing method according to claim 1, before performing a step of obtaining a sharing request of a sharing user for sharing a stake resource with at least one shared user, further comprising:
performing credibility verification on the sharing user based on an access request of the sharing user for a recommended item;
upon determining that the verification succeeds, sending a resource label of a recommended stake resource to the sharing user; and
establishing a recommended stake relationship between the sharing user and the recommended stake resource based on a pickup request of the sharing user for the recommended stake resource, wherein
the stake resource is a part or a whole of the recommended stake resource, and the recommended stake relationship comprises the stake relationship.

7. The stake sharing processing method according to claim 1, wherein there are a plurality of stake resources; and
the method further comprises:
upon determining that it is detected that the sharing user or the target user submits an access request for the stake resource, querying a resource status of the stake resource to obtain a remaining stake resource whose resource status is an unused state; and
displaying a resource label of the stake resource to the sharing user or the target user based on a quantity of remaining stake resources.

8. The stake sharing processing method according to claim 1, wherein the resource parameter comprises a resource type, a sharing time, and/or a resource status; and
correspondingly, the determining whether a resource parameter of the stake resource meets a corresponding sharing condition comprises:
determining whether the resource type of the stake resource is a shareable resource type, determining whether the sharing time is in a sharing time interval, and/or determining whether the resource status of the stake resource is an unused state.

9. The stake sharing processing method according to claim 1, wherein the at least one shared user is determined by using the following method:
when it is detected that the sharing user triggers a sharing control of the stake resource, querying whether the sharing user sets a default shared user; and
upon determining that the sharing user sets the default shared user, determining the default shared user as the at least one shared user.

10. The stake sharing processing method according to claim 9, wherein if an execution result after performing an operation of querying whether the sharing user sets a default shared user is that the sharing user sets no default shared user, the following sub-steps are performed:
generating a user selection page based on a friend list of the sharing user; and
when it is detected that the sharing user triggers a sharing confirmation control configured on the user selection page, determining that at least one user selected by the sharing user by using the user selection page, and/or at least one user queried and selected by the sharing user by using the user selection page is the at least one shared user.

11. The stake sharing processing method according to claim 1, wherein if an execution result after performing a step of determining whether a resource parameter of the stake resource meets a corresponding sharing condition is that the resource parameter of the stake resource does not meet the corresponding sharing condition, the following operations are performed:
reading a sharing failure cause based on a determining result; and
sending a sharing failure reminder to the sharing user based on the sharing failure cause.

12. (canceled)

13. (canceled)

14. (canceled)

15. (canceled)

16. (canceled)

17. (canceled)

18. (canceled)

19. (canceled)

20. A stake sharing processing device, comprising
a memory and a processor, wherein the memory stores executable instructions that, in response to execution by the processor, cause the processor to:
obtain a sharing request of a sharing user for sharing a stake resource with at least one shared user;
perform credibility verification on the at least one shared user based on the sharing request, to obtain a user set of a target user passing the verification;
determine whether a resource parameter of the stake resource meets a corresponding sharing condition; and
upon determining that the resource parameter of the stake resource meets the corresponding sharing condition, add the target user to a stake relationship between the sharing user and the stake resource, so that the target user obtains a resource permission of the stake resource.

21. (canceled)

22. (canceled)

23. A non-transitory computer-readable storage medium comprising instructions stored therein that, when executed by a processor of a computing device, cause the processor to:
obtain a sharing request of a sharing user for sharing a stake resource with at least one shared user;
perform credibility verification on the at least one shared user based on the sharing request, to obtain a user set of a target user passing the verification;
determine whether a resource parameter of the stake resource meets a corresponding sharing condition; and
upon determining that the resource parameter of the stake resource meets the corresponding sharing condition, add the target user to a stake relationship between the sharing user and the stake resource, so that the target user obtains a resource permission of the stake resource.

24. (canceled)

25. (canceled)
